(19) United States
(12) Patent Application Publication
(10) Pub. No.: US 2026/0355682 A1
(43) Pub. Date: Nov. 12, 2026

(54) GAS TREATMENT APPARATUS

(71) Applicant: SAMSUNG ELECTRONICS CO., LTD., Suwon-si (KR)

(72) Inventors: Kyounghwan Lee, Suwon-si (KR); Hayeon Kim, Suwon-si (KR); Hyunju Son, Suwon-si (KR); Seok Ho Yoon, Suwon-si (KR); Joonhyung Cho, Suwon-si (KR)

(73) Assignee: SAMSUNG ELECTRONICS CO., LTD., Suwon-si (KR)

(21) Appl. No.: 19/347,128

(22) Filed: Oct. 1, 2025

(30) Foreign Application Priority Data
May 12, 2025 (KR) 10-2025-0061301

(51) Int. Cl. B01D 53/14; B01D 53/18; H05H 1/24

(52) U.S. Cl. CPC B01D 53/1493; B01D 53/1487; B01D 53/185; H05H 1/247; B01D 2252/103; B01D 2257/406; B01D 2257/702; B01D 2258/0216; H05H 2245/20

(57) ABSTRACT

A gas treatment apparatus according to an embodiment includes: a scrubber; and a plasma-activated water producing module that is connected to the scrubber and supplies plasma-activated water, wherein the plasma-activated water producing module includes: a plasma reactor that excites a plasma generating gas into a plasma state; at least one reactor where plasma supplied from the plasma reactor and an activated water producing liquid are mixed and plasma-activated water is produced; and a storage tank that is connected to the at least one reactor and stores the plasma-activated water produced in the at least one reactor.

### CROSS-REFERENCE TO RELATED APPLICATION

This application claims priority to and the benefit of Korean Patent Application No. 10-2025-0061301 filed with the Korean Intellectual Property Office on May 12, 2025, the entire contents of which are incorporated herein by reference.

### BACKGROUND

### FIELD

The present disclosure relates to a gas treatment apparatus.

### DESCRIPTION OF RELATED ART

Among various processes for manufacturing a semiconductor device, steps such as deposition and etching utilize a substrate treatment device that includes a process chamber. The substrate treatment device uses various gases in a treatment process. Such gas is discharged together with a material generated during the substrate treatment process. When a discharge is released directly into an external space, it causes environmental problems. To prevent this, the gas discharged from the substrate treatment device is processed through a scrubber device and then discharged to the outside. Such a scrubber device may remove a material contained in a gas by spraying liquid into the gas.

### SUMMARY

Embodiments are intended to provide a gas treatment apparatus that can effectively treat gas and remove a material contained in the gas.

However, the problems that embodiments of the present disclosure seek to solve are not limited to the problems described above, and can be expanded in various ways within the range of technical ideas included in the present disclosure.

A gas treatment apparatus according to one aspect may include a gas treatment apparatus including: a scrubber; and a plasma-activated water producing module that is connected to the scrubber and that is configured to supply plasma-activated water, wherein the plasma-activated water producing module includes: a plasma reactor that is configured to excite a plasma generating gas into a plasma state; at least one reactor that is configured to mix plasma supplied from the plasma reactor and an activated water producing liquid and that is configured to produce plasma-activated water; and a storage tank that is connected to the at least one reactor and that is configured to store the plasma-activated water produced in the at least one reactor.

A gas treatment apparatus according to another aspect may include: a scrubber; and a plasma-activated water producing module that is connected to the scrubber and that is configured to supply plasma-activated water to the scrubber, wherein the plasma-activated water producing module includes: a plasma reactor including at least one reactor module that is configured to excite a plasma generating gas into a plasma state; at least one reactor that is configured to mix plasma and activated water producing liquid that is configured to produce plasma-activated water; a plasma supply line that connects the plasma reactor and the at least one reactor and that is configured to supply plasma to the reactor; a gas circulation line that connects the at least one reactor and the plasma reactor and that is configured to supply gas discharged from the at least one reactor to the plasma reactor; and a storage tank that is connected to the bottom of the at least one reactor and that is configured to store plasma-activated water produced in the at least one reactor.

A gas treatment apparatus according to still another aspect may include: a scrubber; a plasma-activated water producing module that that is configured to produce plasma-activated water by dissolving plasma into an activated water producing liquid; an activated water supply line that connects the plasma-activated water producing module and the scrubber and that is configured to supply plasma-activated water to the scrubber; and a manufacturing liquid supply line that connects the scrubber and the plasma-activated water producing module and that is configured to supply an activated-water producing liquid to the plasma-activated water producing module, wherein the plasma-activated water producing module includes: a plasma reactor including at least one reactor module that is configured to excite a plasma generating gas into a plasma state; at least one reactor that is configured to mix plasma and the activated water producing liquid and that is configured to produce plasma-activated water; a plasma supply line that connects the plasma reactor and the at least one reactor and that is configured to supply plasma to the at least one reactor; a gas circulation line that connects the at least one reactor and the plasma reactor and that is configured to supply gas discharged from the at least one reactor to the plasma reactor; and a storage tank that is connected to the at least one reactor and that is configured to plasma-activated water produced in the at least one reactor.

According to the embodiments, a gas treatment apparatus that effectively treats gas and removes material contained in the gas can be provided.

### BRIEF DESCRIPTION OF DRAWINGS

FIG. 1 shows a connection state of a gas treatment apparatus according to an embodiment.

FIG. 2 shows the plasma-activated water producing module of FIG. 1.

FIG. 3 shows a plasma reactor of FIG. 2.

FIG. 4 shows a reactor module of FIG. 3.

FIG. 5 shows the region A of FIG. 4.

FIG. 6 is a cross-sectional view of FIG. 4, taken along the line B-B’.

FIG. 7 shows a reactor and a storage tank according to an embodiment.

FIG. 8 shows a scrubber according to an embodiment.

FIG. 9 is a graph showing the degree of removal of ammonia contained in gas when the gas is treated using the plasma-activated water in the scrubber.

FIG. 10 is a graph showing the degree of removal of ammonia contained in gas when the gas is treated using a sulfuric acid aqueous solution in the scrubber.

FIG. 11 is a graph that shows the change in total hydrocarbon (THC) contained in gas when treating gas using a sulfuric acid aqueous solution and when treating gas using plasma activated water (PAW).

FIG. 12 shows a plasma-activated water producing module according to another embodiment.

FIG. 13 shows a plasma-activated water producing module according to another embodiment.

FIG. 14 shows a plasma-activated water producing module according to another embodiment.

FIG. 15 shows a reactor and a storage tank according to another embodiment.

FIG. 16 shows a scrubber according to another embodiment.

FIG. 17 shows a scrubber according to another embodiment.

### DETAILED DESCRIPTION OF EMBODIMENTS

Hereinafter, with reference to the accompanying drawings, various embodiments of the present disclosure are described in detail such that a person of ordinary skill in the art to which the present disclosure belongs can easily practice the disclosure. The present disclosure may be implemented in many different forms and is not limited to the embodiments described herein.

In order to clearly describe the present disclosure, parts that are not related to the description have been omitted, and the same reference symbols are used for identical or similar components throughout the specification.

In addition, the size and thickness of each component shown in the drawings are arbitrarily shown for better understanding and ease of description, and thus the present disclosure is not necessarily limited to what is shown. In the drawings, the thickness of layers, films, panels, regions, and the like are exaggerated for clarity. In addition, in the drawings, for better understanding and ease of description, the thickness of some layers and regions is exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, throughout the specification, the word “on” in regard to a target element will be understood to be positioned above or below the target element, and will not necessarily be understood to be positioned “at an upper side” based on a direction opposite to gravity.

In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” can mean viewing a target portion from the top, and the phrase “on a cross-section” can mean viewing a cross-section formed by vertically cutting a target portion from the side.

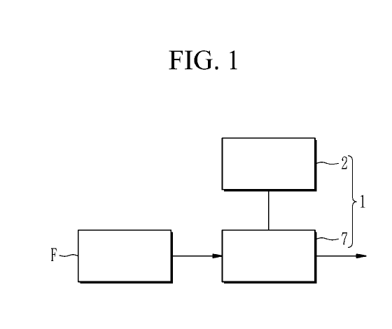

FIG. 1 shows a connection state of a gas treatment apparatus 1 according to an embodiment.

Referring to FIG. 1, a gas treatment apparatus 1 according to an embodiment may include a plasma-activated water producing module 2 and a scrubber 7.

The gas treatment apparatus 1 according to an embodiment may be configured to flow pre-treatment gas into the apparatus, treat the pre-treatment gas, and then discharge the treated gas as post-treatment gas.

The pre-treatment gas may be a gas discharged from a production facility F. For example, the production facility F may be a semiconductor production facility. The semiconductor production facility may perform substrate processing processes using chemicals. Thus, gas discharged from the semiconductor production facility may contain chemicals. The pre-treatment gas flowing into the gas processing device 1 may be gas discharged from the semiconductor production facility or gas discharged from the semiconductor production facility that has been primarily processed.

The plasma-activated water producing module 2 may produce plasma-activated water. The plasma-activated water producing module 2 may produce the plasma-activated water by dissolving excited plasma in liquid. The liquid used in producing the plasma-activated water may include water. The liquid used in producing the plasma-activated water may be water. The plasma-activated water producing module 2 may be connected to the scrubber 7 and supply the plasma-activated water to the scrubber 7.

The scrubber 7 may treat the pre-treatment gas when it flows in, and then discharge the treated gas as post-treatment gas. The scrubber 7 may treat the pre-treatment gas using the plasma-activated water supplied from the plasma-activated water producing module 2 and then discharge the treated gas.

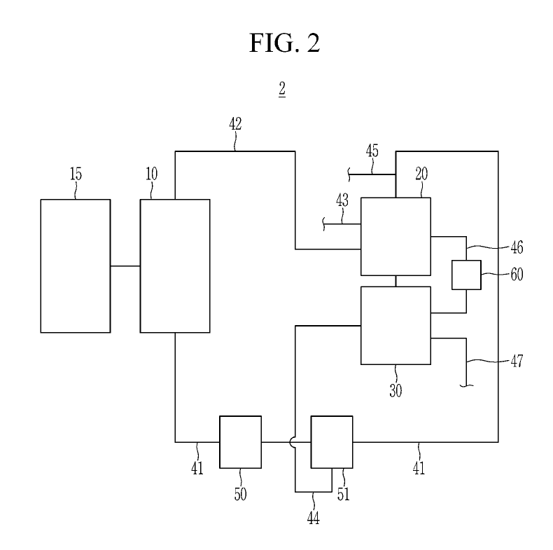

FIG. 2 shows the plasma-activated water producing module 2 of FIG. 1.

Referring to FIG. 2, the plasma-activated water producing module 2 may include a plasma reactor 10, a reactor 20, and a storage tank 30.

Hereinafter, based on a point of the plasma-activated water producing module 2, a direction in which the fluid flows toward the point is called upstream, and a direction in which the fluid flows out from the point is called downstream.

The plasma-activated water producing module 2 may be connected to the scrubber 7 through the activated water supply line 47 and supply the plasma-activated water to the scrubber 7. The scrubber 7 may be connected to the plasma-activated water producing module 2 through a manufacturing liquid supply line 43, and thus may supply the activated water manufacturing liquid to the plasma-activated water producing module 2.

The plasma reactor 10 may excite gas for generating plasma into a plasma state. The plasma generating gas may include oxygen gas and nitrogen gas. For example, the plasma generating gas may be air and the like. The plasma reactor 10 may be connected to an excitation power member 15. The excitation power member 15 provides power for the plasma reactor 10 to excite the plasma generating gas into a plasma state. For example, the excitation power member 15 may apply a voltage of which the magnitude varies over time to the plasma reactor 10. For example, the excitation power member 15 may supply electric power to the plasma reactor 10 in the form of an AC voltage, a pulse voltage, and the like.

The voltage applied by the excitation power member 15 may have a predetermined frequency. The frequency of the voltage applied by the excitation power member 15 may maintain a predetermined range. In addition, the excitation power member 15 may also supply a voltage of which a frequency changes over time.

The magnitude of the electric power applied by the excitation power member 15 may maintain a predetermined magnitude. In addition, the excitation power member 15 may also supply electric power in a form that changes size over time.

The plasma reactor 10 may be connected to a gas circulation line 41. The gas proceeds toward the plasma reactor 10 inside the gas circulation line 41 and thus the gas may flow from the gas circulation line 41 into the plasma reactor 10. Thus, one end of the gas circulation line 41 connected to the plasma reactor 10 may be called a downstream side end of the gas circulation line 41. The gas flowing into the plasma reactor 10 from the gas circulation line 41 may include plasma generating gas. The gas flowing from the gas circulation line 41 to the plasma reactor 10 may include gas discharged from a reactor 20.

The reactor 20 may be connected to the plasma reactor 10 through a plasma supply line 42. The plasma excited in the plasma reactor 10 may be supplied to the reactor 20 through the plasma supply line 42. Thus, one end of the plasma supply line 42 connected to the plasma reactor 10 may be called an upstream side end of the plasma supply line 42, and the other end connected to the reactor 20 may be called a downstream side end of the plasma supply line 42.

The reactor 20 may produce plasma-activated water by mixing plasma supplied from the plasma reactor 10 and liquid for producing activated water through the plasma supply line 42. That is, the plasma is dissolved in the activated water producing liquid in the reactor 20 such that the plasma-activated water can be produced. The activated water producing liquid may include water. For example, the activated water producing liquid may be water. In this case, the liquid for producing activated water does not need to be pure, and may contain a foreign substance dissolved in the water.

The reactor 20 may be connected to the manufacturing liquid supply line 43. The activated water producing liquid flows toward the reactor 20 in the manufacturing liquid supply line 43, and one end of the manufacturing liquid supply line 43 connected to the reactor 20 may be called a downstream side end of the manufacturing liquid supply line 43. For example, the activated water producing liquid supplied to the reactor 20 through the manufacturing liquid supply line 43 may be water.

The upstream side end of the gas circulation line 41 may be connected to the reactor 20. Accordingly, gas inside the reactor 20 may be supplied to the plasma reactor 20 through the gas circulation line 41. The gas flowing from the reactor 20 into the gas circulation line 41 may contain plasma remaining after being dissolved in the activated water producing liquid inside the reactor 20.

A circulation member 50 may be disposed on the gas circulation line 41. The circulation member 50 may provide a pressure for the gas to flow toward the downstream side end of the gas circulation line 41. The circulation member 50 may be a blower, a pump, and the like.

A dehumidifying member 51 may be disposed on the gas circulation line 41. The dehumidifying member 51 may remove moisture contained in the gas flowing through the gas circulation line 41. In addition, the dehumidifying member 51 may remove mist included in the gas flowing through the gas circulation line 41. The dehumidifying member 51 may be positioned on the upstream side of the gas circulation line 41 relative to the circulation member 50. Accordingly, moisture and mist contained in the gas flowing through the gas circulation line 41 can be prevented from contacting the circulation member 50.

The dehumidifying member 51 may be connected to an upstream side end of a liquid discharge line 44. The liquid discharge line 44 may discharge liquid separated from the gas by the dehumidifying member 51.

The gas circulation line 41 may be connected to the gas supply line 45. The gas supply line 45 may supply the plasma generating gas to the gas circulation line 41. Accordingly, one end of the gas supply line 45 connected to the gas circulation line 41 may be called a downstream side end of the gas supply line 45. The plasma generating gas supplied through the gas supply line 45 may be introduced into the plasma reactor 10 together with the gas flowing into the gas circulation line 41 from the reactor 20. The downstream side end of the gas supply line 45 may be connected to the gas circulation line 41 in an upstream side relative to the dehumidifying member 51. Accordingly, moisture included in the plasma generating gas supplied through the gas supply line 45 may be removed through the dehumidifying member 51.

The plasma that flows into the reactor 20 through the plasma supply line 42 disappears in the process of being dissolved in the activated water producing liquid in the reactor 20. Accordingly, an internal pressure of the upstream side end of the gas circulation line 41 may be lower than an internal pressure of the downstream side end of the plasma supply line 42. Accordingly, in order to form the flow direction of gas in the gas circulation line 41 from the reactor 20 toward the plasma reactor 10, the circulation member 50 may be disposed on the gas circulation line 41.

Additionally, due to exhaustion of the plasma inside the reactor 20, the pressure inside the upstream side end of the gas circulation line 41 may become lower than the atmospheric pressure. Thus, when the pressure at the upstream side end of the gas supply line 45 is set to the atmospheric pressure state, the plasma generating gas may flow from the upstream side end of the gas supply line 45 to the downstream side end and be supplied to the gas circulation line 41. Accordingly, the pressure inside the downstream side end of the gas circulation line 41 and the plasma supply line 42 may correspond to the atmospheric pressure or be less than the atmospheric pressure. As the plasma is exhausted in the reactor 20, the pressure inside the upstream side of the gas circulation line 41 becomes lower than the pressure inside the plasma supply line 42. Accordingly, the plasma generating gas can flow into the gas circulation line 41 through the gas supply line 45. That is, the amount of inflow of the plasma generating gas through the gas supply line 45 may be controlled according to the amount of plasma consumed according to the operation status of the plasma-activated water producing module 2. For example, the upstream side end of the gas supply line 45 may be exposed to the atmosphere. Accordingly, air can be supplied to the gas circulation line 41 through the gas supply line 45 by a pressure difference between the atmospheric pressure and the pressure inside the gas circulation line 41 of a region to which the downstream side end of the gas supply line 45 is connected.

The storage tank 30 and the reactor 20 may be connected to each other. The plasma-activated water generated in the reactor 20 may be transferred to the storage tank 30. For example, the storage tank 30 is connected to a lower portion of the reactor 20 and the plasma-activated water generated in the reactor 20 may move to the storage tank 30 by gravity. In addition, the storage tank 30 is connected to the reactor 20 through a pipe, and the plasma-activated water generated in the reactor 20 may move to the storage tank 30 through the pipe. The storage tank 30 may be connected to the upstream side end of the activated water supply line 47. The downstream side end of the activated water supply line 47 may be connected to the scrubber 7. The plasma-activated water may be supplied to the scrubber 7 from the storage tank 30 through the activated water supply line 47.

The storage tank 30 and the reactor 20 may be connected by a liquid circulation line 46. An upstream side end of the liquid circulation line 46 may be connected to the storage tank 30, and a downstream side end of the liquid circulation line 46 may be connected to the reactor 20. The plasma-activated water stored in the storage tank 30 may be supplied to the reactor 20 through the liquid circulation line 46. After that, the plasma-activated water supplied to the reactor 20 may react with plasma in the reactor. That is, the plasma-activated water may circulate between the storage tank 30 and the reactor 20 through the liquid circulation line 46. Accordingly, the concentration may be prevented from decreasing over time after the plasma-activated water flows into the storage tank 30. A liquid circulation member 60 may be disposed on the liquid circulation line 46. The liquid circulation member 60 may be a pump and the like. The liquid circulation member 60 may provide pressure to cause liquid to flow from the upstream side end of the liquid circulation line 46 to the downstream side end.

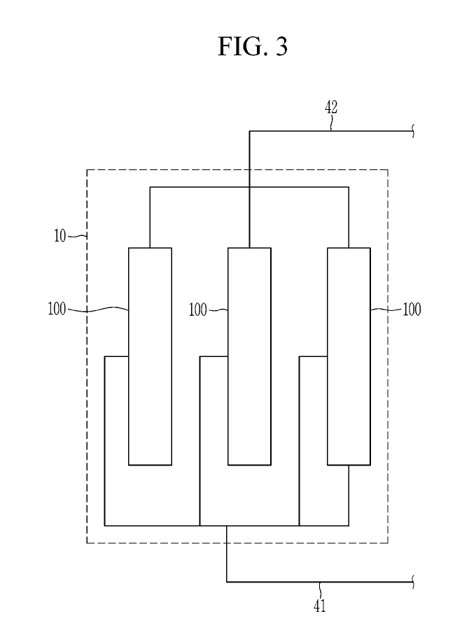

FIG. 3 shows the plasma reactor 10 of FIG. 2.

Referring to FIG. 3, the plasma reactor 10 may include at least one reactor module 100. When the plasma reactor 10 includes a plurality of reactor modules 100, the plurality of reactor modules 100 may be arranged in parallel. That is, each of the plurality of reactor modules 100 may be connected to the downstream side end of the gas circulation line 41 and the upstream side end of the plasma supply line 42. In FIG. 3, the plasma reactor 10 include three reactor modules 100. However, this is an example, and the number of reactor modules 100 included in the plasma reactor 10 may vary depending on the amount of plasma required by the reactor 20.

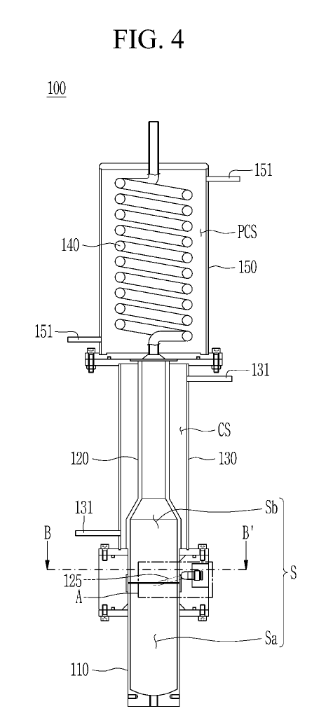

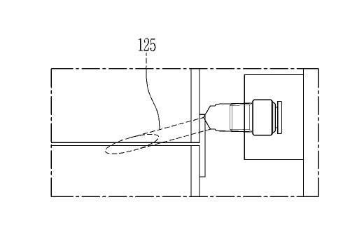

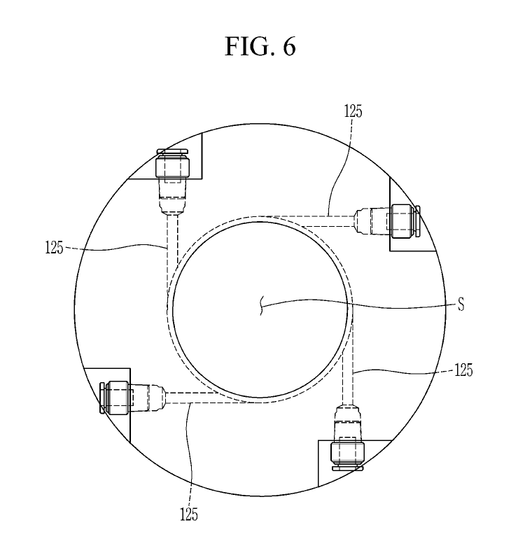

FIG. 4 shows the reactor module 100 of FIG. 3, FIG. 5 shows the region A of FIG. 4, and FIG. 6 is a cross-sectional view of FIG. 4, taken along the line B-B’.

Referring to FIG. 4 to FIG. 6, the reactor module 100 may include a negative electrode 110, a positive electrode 120, an electrode cover 130, a discharge path member 140 and a path cover 150.

The negative electrode 110 is disposed at one side of the reactor module 100. The negative electrode 110 has a container structure having a predetermined length in one direction, and a negative electrode side space Sa may be formed therein. One end of the negative electrode 110 may have a structure of which on end is opened to the outside.

The positive electrode 120 is disposed at the other side of the reactor module 100. The positive electrode 120 has a pipe structure having a predetermined length, and a positive electrode side space Sb may be formed therein. When the positive electrode 120 is connected to one side of the negative electrode 110, the negative electrode side space Sa and the positive electrode side space Sb may be a plasma excitation space S. The positive electrode 120 may be disposed such that its length direction is aligned with a length direction of the negative electrode 110. The area of the positive electrode side space Sb in a direction perpendicular to the length direction of the positive electrode 120 may vary by region. In the area of the positive electrode side space Sb in a direction perpendicular to the length direction of the positive electrode 120, one end facing toward the negative electrode 110 may be provided larger than the other end facing toward the opposite direction of the negative electrode 110. One end of the positive electrode side space Sb facing the negative electrode 110 has a shape corresponding to the negative electrode side space Sa at one end of the negative electrode 110, and one end of the positive electrode side space Sb and one end of the negative electrode side space Sa may be aligned with each other. The other end of the positive electrode side space Sb may be an outlet through which plasma is discharged.

At least one insertion line 125 may be connected to the plasma excitation space S. For example, the insertion line 125 may be connected to a region where the negative electrode 110 and the positive electrode 120 are connected to each other. The insertion line 125 supplies plasma generating gas to the plasma excitation space S. The insertion line 125 may be connected to the gas circulation line 41. With reference to a cross-section perpendicular to the length direction of the positive electrode 120, a length direction of the insertion line 125 may be positioned eccentrically with respect to the center of the plasma excitation space S. The insertion line 125 is provided in plurality, and the plurality of insertion lines 125 may be disposed at a distance from each other along a circumferential direction of the plasma excitation space S. Accordingly, the plasma generating gas supplied through the insertion line 125 may form a helical vortex in the plasma excitation space S. The insertion line 125 may be inclined in its length direction from the positive electrode 120 to the negative electrode 110 as it goes into the plasma excitation space S. Accordingly, the plasma generating gas supplied to the plasma excitation space S through the insertion line 125 may proceed in a direction from the positive electrode 120 toward the negative electrode 110.

The excitation power member 15 may be connected to the negative electrode 110. The excitation power member 15 may apply a voltage of which the magnitude changes over time. For example, the excitation power member 15 may be connected to an end positioned in the opposite direction of the positive electrode 120 in the negative electrode 110. That is, the excitation power member 15 may be connected to the negative electrode 110 at one end in the length direction of the negative electrode 110. The positive electrode 120 may be grounded. When the excitation power member 15 supplies power while the plasma generating gas is being supplied, the plasma excitation space S becomes a passage through which the arc glides. In addition, when the arc reaches the opposite direction end of the positive electrode 120 from the negative electrode 110, a reserve vertex flow (RVF) is formed, which can generate a discharge column. The plasma generating gas may generate radicals through arc discharge. The radicals generated through the arc discharge may include reactive nitrogen species and reactive oxygen species.

The electrode cover 130 may be provided to cover at least a portion of the exterior side of the positive electrode 120. A electrode cooling space CS may be formed between the electrode cover 130 and an exterior side of the positive electrode 120. At least two refrigerant holes 131 may be formed in the electrode cover 130. Accordingly, a refrigerant may be supplied to the electrode cooling space CS through one of the refrigerant holes 131, and the refrigerant may be discharged from the electrode cooling space CS through the other one of the refrigerant holes 131. The positive electrode 120 may be cooled through the refrigerant supplied to the electrode cooling space CS.

One end of the discharge path member 140 may be connected to the positive electrode 120. The discharge path member 140 may be connected to the positive electrode 120 by having a structure in which one end directly contacts the positive electrode 120. The discharge path member 140 may be connected to the other end of the positive electrode 120 disposed opposite the negative electrode 110. Accordingly, plasma may flow into the discharge path member 140 from the plasma excitation space S. The discharge path member 140 may form a path having a predetermined length. The discharge path member 140 may have a curved line structure in at least some portions. For example, the discharge path member 140 may have a spiral structure in at least some portions. Accordingly, a length of the path by the discharge path member 140 may be longer than a straight line distance between the two ends of the discharge path member 140. The other end of the discharge path member 140 may be connected to the plasma supply line 42. Accordingly, plasma discharged from the plasma excitation space S may flow into the plasma supply line 42 through the discharge path member 140.

The path cover 150 may be provided to surround at least some of an exterior surface of the discharge path member 140. A plasma cooling space PCS may be formed between the path cover 150 and the exterior surface of the discharge path member 140. At least two discharge-side refrigerant holes 151 may be formed in the path cover 150. Thus, a refrigerant is supplied to the plasma cooling space PCS through one of the discharge-side refrigerant holes 151, and a refrigerant may be discharged from the plasma cooling space PCS through the other one of the discharge-side refrigerant holes 151. The discharge path member 140 and plasma flowing through the discharge path member 140 may be cooled by the refrigerant supplied to the plasma cooling space PCS.

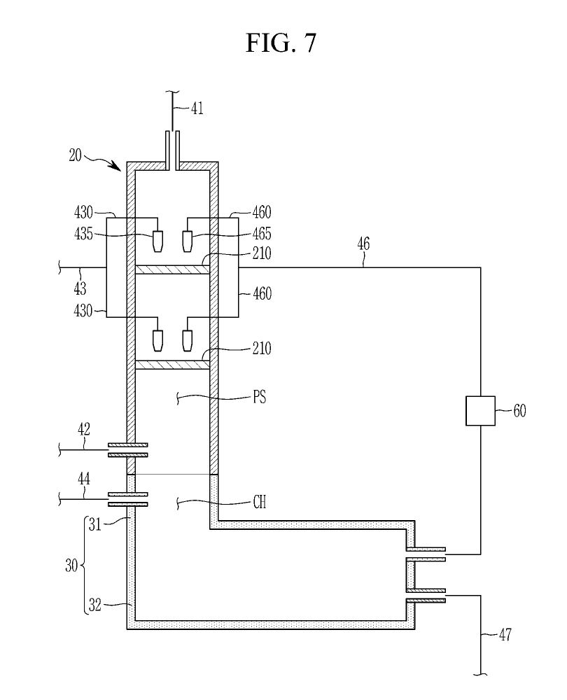

FIG. 7 shows the reactor 20 and the storage tank 30 according to an embodiment.

Referring to FIG. 7, the reactor 20 may have a predetermined height in a vertical direction. A producing space PS in which plasma is dissolved in the activated water producing liquid is disposed in the reactor 20. A lower end of the reactor 20 is opened, and thus a lower end of the producing space PS may be connected to the outside.

At least one reaction auxiliary member 210 may be disposed inside the reactor 20. The reaction auxiliary member 210 may have a plate structure having a predetermined thickness and a predetermined area. The reaction auxiliary member 210 is disposed inside the reactor 20 such that the producing space PS may be partitioned into a plurality of zones. For example, the reaction auxiliary member 210 may be disposed such that the producing space PS can be partitioned into a plurality of regions along the vertical direction.

When the reaction auxiliary member 210 is provided in plurality, the plurality of reaction auxiliary members 210 may be disposed at a distance from each other in the vertical direction.

The reaction auxiliary member 210 may allow a fluid to flow therethrough. For example, the reaction auxiliary member 210 may be provided as a mesh structure or a sponge structure in the form of open cells with connected pores.

The plasma supply line 42 may be connected to the reactor 20 and supply plasma to the producing space PS. The plasma supply line 42 may be connected to a lower portion of the reactor 20. At least one reaction auxiliary member 210 may be disposed in an upper side of a region where the plasma supply line 42 is connected in the reactor 20. For example, the region to which the plasma supply line 42 is connected in the reactor 20 may be disposed below the bottommost reaction auxiliary member 210.

The manufacturing liquid supply line 43 may be connected to the reactor 20. A nozzle 435 may be connected to a downstream side end of the manufacturing liquid supply line 43. The nozzle 435 may spray activated water producing liquid toward the producing space PS.

The nozzle 435 may be disposed above at least one reaction auxiliary member 210. A downstream side end of the manufacturing liquid supply line 43 may include a plurality of branch supply lines 430. That is, the downstream side end of the manufacturing liquid supply line 43 may be branched to a plurality of branch supply lines 430. The plurality of branch supply lines 430 may be connected to the reactor 20 at different heights in the vertical direction. A nozzle 435 may be connected to each of the downstream side ends of the branch supply lines 430. Each nozzle 435 may be disposed to match a reaction auxiliary member 210 one by one in the vertical direction.

Thus, plasma supplied through the plasma supply line 42 is dissolved into a liquid sprayed from the nozzle 435 such that plasma-activated water can be produced.

The upstream side end of the gas circulation line 41 may be connected to an upper portion of the reactor 20. The upstream side end of the gas circulation line 41 may be connected to the reactor 20 above the topmost reaction auxiliary member 210.

The storage tank 30 may be connected to a lower portion of the reactor 20. For example, a connection hole CH opened to the outside may be disposed in an upper portion of the storage tank 30. The connection hole CH may have a shape corresponding to a lower end of the producing space PS of the reactor 20. In addition, the storage tank 30 may be connected to the reactor 20 with a structure in which the connection hole CH is aligned with the lower end of the producing space PS along the vertical direction. Accordingly, plasma-activated water dropped from the reactor 20 may flow into the storage tank 30.

The storage tank 30 may include an inflow portion 31 and a storage portion 32.

The inflow portion 31 may be disposed in an upper portion of the storage tank 30. The connection hole CH may be disposed in the upper portion of the inflow portion 31.

The storage portion 32 may be disposed in a lower portion of the storage tank 30. The storage portion 32 may be connected to the lower portion of the inflow portion 31. The area of the internal space along the direction orthogonal to the vertical direction may be provided to be larger in the storage portion 32 than in the inflow portion 31. Accordingly, a sufficient among of plasma-activated water can be stored in the storage tank 30.

The downstream side end of the liquid discharge line 44 may be connected to the storage tank 30. Thus, liquid discharged from the dehumidifying member 51 may flow into the storage tank 30. A downstream side end of the liquid discharge line 44 may be connected to the inflow portion 31.

An upstream side end of the liquid circulation line 46 may be connected to the storage portion 32.

The downstream side end of the liquid circulation line 46 may be connected to the reactor 20. A circulation nozzle 465 may be connected to the downstream side end of the liquid circulation line 46. The circulation nozzle 465 may spray liquid flowing through the liquid circulation line 46 to the producing space PS. The circulation nozzle 465 may be disposed above at least one reaction auxiliary member 210. The downstream side end of the liquid circulation line 46 may include a plurality of branch circulation lines 460. That is, the downstream end of the liquid circulation line 46 may be branched into a plurality of branch circulation lines 460. The plurality of branch circulation lines 460 may be connected to the reactor 20 at different heights in the vertical direction. The circulation nozzle 465 may be connected to a downstream side end of each branch circulation line 460. Each circulation nozzle 465 may be disposed to match one-to-one with each reaction auxiliary member 210 in the vertical direction.

The upstream side end of the activated water supply line 47 may be connected to the storage portion 32 of the storage tank 30.

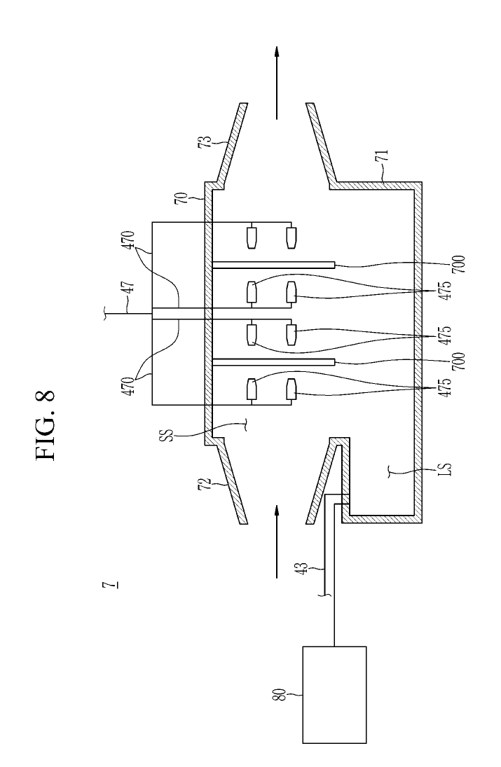

FIG. 8 shows the scrubber 7 according to an embodiment.

Referring to FIG. 8, the scrubber 7 may include a gas purification portion 70 and a liquid storage portion 71.

A gas purification space SS in which gas is purified by reacting with the plasma-activated water may be provided in the gas purification portion 70. The gas purification portion 70 may have a predetermined length along a length direction. The length direction of the gas purification portion 70 may cross the vertical direction. The gas purification portion 70 may have a structure in which both ends in the length direction are open, and a gas inflow portion 72 may be disposed at one end in the length direction of the gas purification portion 70, and a gas discharge portion 73 may be disposed at the other end in the length direction of the gas purification portion 70. Pre-treatment gas may flow into the gas inflow portion 72, and post-treatment gas may be discharged through the gas discharge portion 73.

At least one purification auxiliary member 700 may be disposed inside the gas purification portion 70. The purification auxiliary member 700 may have a plate structure having a predetermined thickness and a predetermined area.

The purification auxiliary member 700 is disposed in the gas purification space SS such that the area between the gas inflow portion 72 and the gas discharge portion 73 may be partitioned into a plurality of zones. When the purification auxiliary member 700 is provided in plurality, a plurality of purification auxiliary members 700 may be disposed spaced apart from each other along the length direction of the gas purification portion 70.

The purification auxiliary member 700 may be provided to be permeable to the fluid. For example, the purification auxiliary member 700 may be provided as a mesh structure or as an open cell sponge structure with connected pores.

The downstream side end of the activated water supply line 47 is connected to the gas purification portion 70 such that the plasma-activated water may be sprayed into the gas purification space SS. For example, the purification nozzle 475 may be disposed inside the gas purification portion 70, and the downstream side end of the activated water supply line 47 may be connected to the purification nozzle 475. The purification nozzle 475 may be disposed to spray the plasma-activated water toward the purification auxiliary member 700. For example, the purification nozzle 475 may be disposed on each side of the purification auxiliary member 700, and thus the plasma-activated water may be sprayed on each side of the purification auxiliary member 700. In addition, the downstream side end of activated water supply line 47 may include a plurality of branch spray lines 470. That is, the downstream side end of the activated water supply line 47 may be branched into the plurality of branch spray lines 470. The plurality of branch spray lines 470 may each be connected to the purification nozzle 475.

The liquid storage portion 71 may be connected to one side of the gas purification portion 70. For example, the liquid storage portion 71 may be connected to a lower portion of the gas purification portion 70. A liquid storage space LS for storing liquid may be disposed inside the liquid storage portion 71. The liquid storage space LS is connected to the gas purification space SS, and thus the plasma-activated water that falls from the gas purification space SS may flow into the liquid storage space LS.

The scrubber 7 may be connected to a supply tank 80. The supply tank 80 may supply the activated water producing liquid to the scrubber 7. The supply tank 80 is connected to the liquid storage portion 71 and thus may supply the activated water producing liquid to the liquid storage space LS.

The scrubber 7 may be connected to the upstream side end of the manufacturing liquid supply line 43. Thus, the activated water producing liquid stored in the scrubber 7 may be supplied to the reactor 20 of the plasma-activated water producing module 2. The upstream side end of the manufacturing liquid supply line 43 may be connected to the liquid storage portion 71.

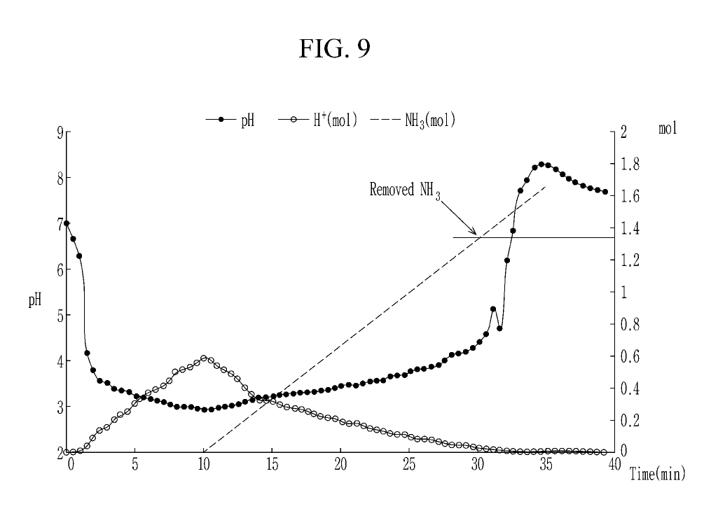

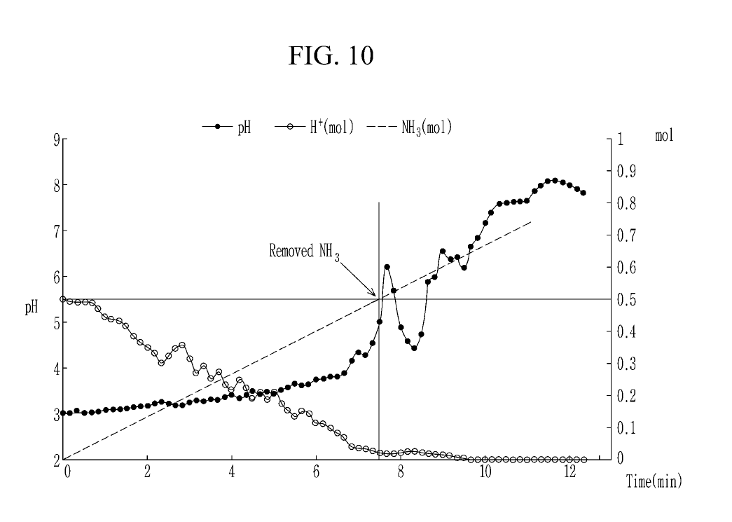

FIG. 9 is a graph showing the degree of removal of ammonia contained in gas when the gas is treated using the plasma-activated water in the scrubber 7. FIG. 10 is a graph showing the degree of removal of ammonia contained in gas when the gas is treated using sulfuric acid aqueous solution in the scrubber 7.

In each graph, the horizontal axis denotes a scrubbing time in the scrubber 7, the left vertical axis denotes pH of the liquid used in the scrubber 7, and the right vertical axis denotes the amount (mol) of ammonia removed in the scrubber 7 and the amount (mol) of residual protons in the liquid used in the scrubber 7.

In the scrubber 7, pre-treatment gas of the same condition flows in at the same flow rate. The liquid used for gas treatment in the scrubber 7 is used in the same amount to reach pH 3.

When the plasma-activated water is used, the pH reached 3 10 minutes after the start of scrubbing due to the time required to produce plasma-activated water in the plasma-activated water producing module 2. Accordingly, the amount of ammonia removal is measured after 10 minutes.

After the protons remaining in the liquid used in the scrubber 7 become 0, gas treatment becomes ineffective. Accordingly, the point at which the proton remaining in the liquid used in the scrubber 7 becomes 0 is the end point.

When the plasma-activated water is used, the ammonia removed at the end point is approximately 1.3 mol. When sulfuric acid aqueous solution is used, the ammonia removed at the end point is approximately 0.5 mol. That is, when plasma-activated water is used, ammonia contained in the pre-treatment gas may be removed more effectively.

That is, the reactive nitrogen species contained in the plasma-activated water react with ammonia, thereby effectively removing the ammonia contained in the pre-treatment gas.

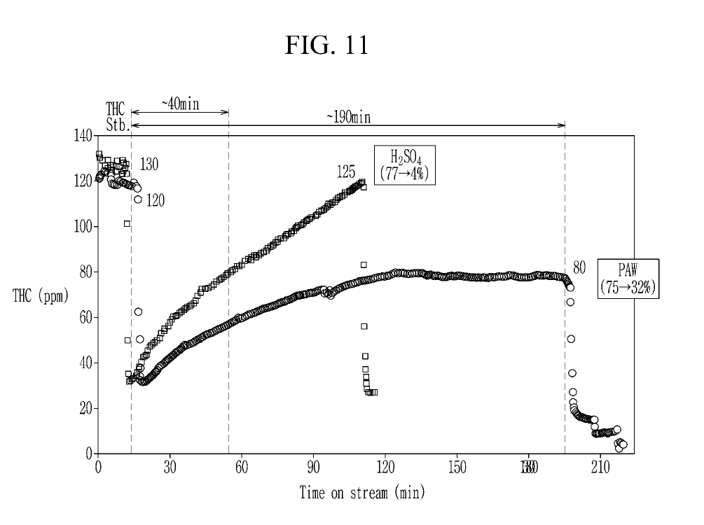

FIG. 11 is a graph that shows the change in total hydrocarbon (THC) contained in gas when treating gas using a sulfuric acid solution and when treating gas using plasma activated water (PAW).

Total hydrocarbon is a concept that comprehensively refers to a compound composed of carbon and hydrogen. That is, total hydrocarbon is a vapor-state hydrocarbon of which a main component is alkane, alkene, alkyne, aromatic, and the like, which is composed of carbon and hydrogen, and is a concept that collectively refers to various composite state carbon compounds instead of chemically distinguishable individual components.

The total hydrocarbon is injected at approximately 120-130 ppm by vaporizing 2-propanol. Total hydrocarbon is injected in a state where the liquid used in the scrubber 7 is pH 3 and the removal efficiency of ammonia is maintained at 99%.

When the sulfuric acid aqueous solution is used for gas treatment in the scrubber 7, the discharge concentration of the total hydrocarbon at the initial injection point is reduced to about 25% of the injection amount. However, over time, the sulfuric acid aqueous solution loses its ability to process total hydrocarbon, and after approximately 120 minutes, the discharge concentration of the total hydrocarbon increased to approach the injection amount.

When the plasma-activated water is used for the gas treatment in the scrubber 7, the discharge concentration of the total hydrocarbon at the initial injection point is similarly reduced to that when sulfuric acid is used. However, over time, the discharge concentration of the total hydrocarbon increased more gradually than that of sulfuric acid. In addition, even after approximately 120 minutes, the discharge concentration of the total hydrocarbon is maintained at 80 ppm for a considerable period of time, indicating that approximately 30% of the injection amount is processed. That is, the plasma-activated water may treat total hydrocarbon by oxidation through reactive oxygen species, and it can be seen that it treats total hydrocarbon more stably than the sulfuric acid aqueous solution.

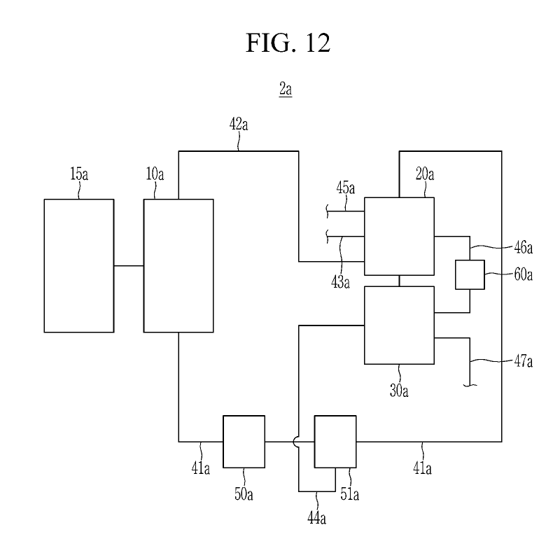

FIG. 12 shows a plasma-activated water producing module 2a according to another embodiment.

Referring to FIG. 12, a plasma-activated water producing module 2a may include a plasma reactor 10a, a reactor 20a, and a storage tank 30a.

The plasma reactor 10a may be connected to an excitation power member 15a. The plasma reactor 10a may be connected to the reactor 20a through a plasma supply line 42a. The plasma reactor 10a may be connected to the reactor 20a through a gas circulation line 41a. A circulation member 50a and a dehumidifying member 51a may be disposed on the gas circulation line 41a. The dehumidifying member 51a may be connected to the storage tank 30a through a liquid discharge line 44a.

The reactor 20a may be connected to the storage tank 30a. The storage tank 30a may be connected to the reactor 20a through a liquid circulation line 46a. A liquid circulation member 60a may be disposed on the liquid circulation line 46a. The reactor 20a may be connected to a manufacturing liquid supply line 43a.

The storage tank 30a may be connected to an activated water supply line 47a.

Except for a gas supply line 45a described below, the plasma reactor 10a, the reactor 20a, the storage tank 30a, and configurations of a structure connected thereto are the same or similar to those described above in FIG. 1 to FIG. 8, and therefore a repeated description is omitted.

The reactor 20a may be connected to a gas supply line 45a. The gas supply line 45a may supply a plasma generating gas. Thus, one side end of the gas supply line 45a connected to the reactor 20a may be called a downstream side end of the gas supply line 45a. The plasma generating gas supplied through the gas supply line 45a flows into the gas circulation line 41a from the reactor 20a and then is supplied to the plasma reactor 10a.

The gas supply line 45a may be connected to an upper portion of the reactor 20a. The gas supply line 45a may be connected to the reactor 20a in a region above the plasma supply line 42a. For example, in the case of the reactor 20 shown in FIG. 7, the gas supply line 45a may be connected to the reactor 20 at an upper region of the uppermost positioned reaction auxiliary member 210.

Due to exhaustion of the plasma inside the reactor 20a, the pressure inside reactor 20a may become lower than the atmospheric pressure. Thus, when the pressure at the upstream side end of the gas supply line 45a is set to the atmospheric pressure state, the plasma generating gas may flow from the upstream side end of the gas supply line 45a to the downstream side end and be supplied to the gas circulation line 41a from reactor 20a. Accordingly, the pressure inside the gas circulation line 41a and inside the plasma supply line 42a may correspond to the atmospheric pressure or may be less than the atmospheric pressure. Due to exhaustion of plasma inside the reactor 20a, the pressure inside the reactor 20a becomes lower than the pressure inside the plasma supply line 42a again. Accordingly, the plasma generating gas may flow into the reactor 20a through the gas supply line 45a. That is, the amount of inflow of the plasma generating gas through the gas supply line 45a may be adjusted according to the amount of plasma consumed according to the operation status of the plasma-activated water producing module 2a. For example, an upstream side end of the gas supply line 45a may be exposed to the atmosphere. Accordingly, air may be supplied to the reactor 20a through the gas supply line 45a by a pressure difference between the atmospheric pressure and the pressure inside the reactor 20a. Afterwards, the plasma generating gas flowing into the gas supply line 45a may flow into the gas circulation line 41a by the negative pressure acting on the gas circulation line 41a side.

In addition, the gas supply line 45a is connected to the reactor 20a in a region above the plasma supply line 42a so as not to interfere with plasma coming into contact with a manufacturing liquid.

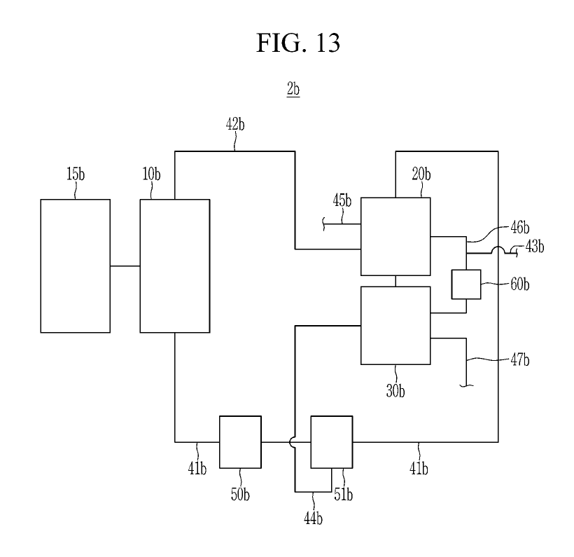

FIG. 13 shows a plasma-activated water producing module 2b according to another embodiment.

Referring to FIG. 13, a plasma-activated water producing module 2b may include a plasma reactor 10b, a reactor 20b, and a storage tank 30b.

The plasma reactor 10b may be connected to an excitation power member 15b. The plasma reactor 10b may be connected to the reactor 20b through a plasma supply line 42b. The plasma reactor 10b may be connected to the reactor 20b through a gas circulation line 41b. A circulation member 50b and a dehumidifying member 51b may be disposed on the gas circulation line 41b. The dehumidifying member 51b may be connected to the storage tank 30b through a liquid discharge line 44b.

The reactor 20b may be connected to the storage tank 30b. The storage tank 30b may be connected to the reactor 20b through a liquid circulation line 46b. A liquid circulation member 60b may be disposed on the liquid circulation line 46b.

The storage tank 30b may be connected to an activated water supply line 47b.

A gas supply line 45b may be connected to the gas circulation line 41b in the same or similar manner as described above in FIG. 1 to FIG. 8. Alternatively, the gas supply line 45b may be connected to the reactor 20b in the same or similar manner as described above in FIG. 12. FIG. 13 shows a case in which the gas supply line 45b is connected to the reactor 20b.

Except for a manufacturing liquid supply line 43b described below, the plasma reactor 10b, the reactor 20b, the storage tank 30b, and configurations of a structure connected thereto are the same or similar to those described above in FIG. 1 to FIG. 8 or FIG. 12, and therefore a repeated description is omitted.

A downstream side end of the manufacturing liquid supply line 43b may be connected to the liquid circulation line 46b. Accordingly, a liquid supplied to the liquid circulation line 46b through the manufacturing liquid supply line 43b may flow into the reactor 20b together with a liquid supplied to the reactor 20b from the storage tank 30b.

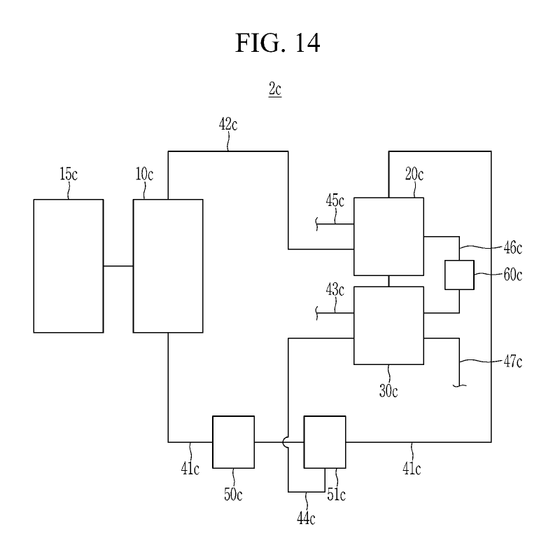

FIG. 14 shows a plasma-activated water producing module 2c according to another embodiment.

Referring to FIG. 14, a plasma-activated water producing module 2c may include a plasma reactor 10c, a reactor 20c, and a storage tank 30c.

The plasma reactor 10c may be connected to an excitation power member 15c. The plasma reactor 10c may be connected to the reactor 20c through a plasma supply line 42c. The plasma reactor 10cmay be connected to the rector 20c through a gas circulation line 41c. A circulation member 50c and a dehumidifying member 51c may be disposed on the gas circulation line 41c. The dehumidifying member 51c may be connected to the storage tank 30c through a liquid discharge line 44c.

The reactor 20c may be connected to the storage tank 30c. The storage tank 30c may be connected to the reactor 20c through a liquid circulation line 46c. A liquid circulation member 60c may be disposed on the liquid circulation line 46c.

The storage tank 30c may be connected to an activated water supply line 47c.

The gas supply line 45c may be connected to the gas circulation line 41c in the same or similar manner as described above in FIGS. 1 to 8. In addition, the gas supply line 45c may be connected to the reactor 20c in the same or similar manner as described above in FIG. 12. FIG. 14 shows a case that the gas supply line 45c is connected to the reactor 20c.

Except for a manufacturing liquid supply line 43c described below, the plasma reactor 10c, the reactor 20c, the storage tank 30c, and configurations of a structure connected thereto are the same or similar to those described above in FIG. 1 to FIG. 8 or FIG. 12, and therefore a repeated description is omitted.

A downstream side end of the manufacturing liquid supply line 43c may be connected to the storage tank 30c. Accordingly, a liquid supplied to the storage tank 30c through the manufacturing liquid supply line 43c may be supplied to the reactor 20c from the storage tank 30c through the liquid circulation line 46c.

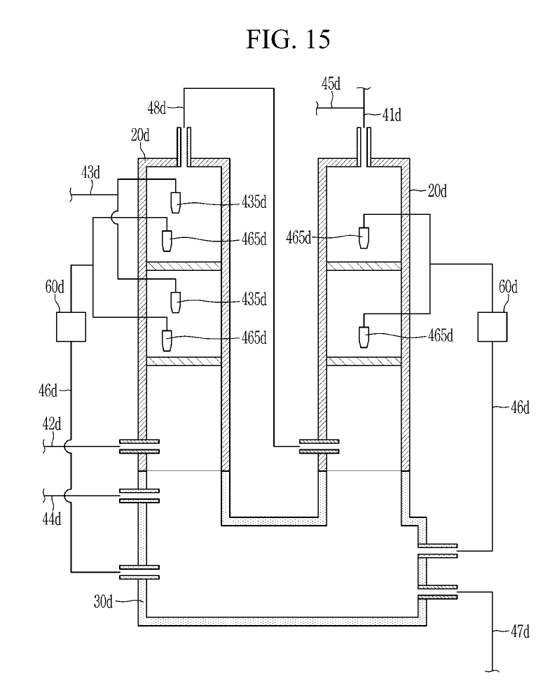

FIG. 15 shows a reactor 20d and a storage tank 30d according to another embodiment.

Referring to FIG. 15, a storage tank 30d may be connected to a plurality of reactors 20d. FIG. 15 exemplarily illustrates a case that two reactors 20d are connected to the storage tank 30d.

Hereinafter, duplicate descriptions of parts that are identical or similar to those described above in FIG. 1 to FIG. 8, FIG. 12, FIG. 13, or FIG. 14 will be omitted and differences will be described.

The plurality of reactors 20d may be connected in series through a reactor connection line 48d. Thus, gas discharged from one of the two reactors 20d connected through the reactor connection line 48d may flow into the other reactor 20d. An upstream side end of the reactor connection line 48d may be connected to an upper region of one reactor 20d. A downstream side end of the reactor connection line 48d may be connected to a lower region of the other reactor 20d.

Each reactor 20d may be connected to the storage tank 30d through a liquid circulation line 46d. Thus, a liquid stored in the storage tank 30d may be supplied to each reactor 20d through the liquid circulation line 46d. A circulation nozzle 465d may be connected to a downstream side end of the liquid circulation line 46d. A liquid circulation member 60d may be disposed in each liquid circulation line 46d.

A plasma supply line 42d may be connected to at least one of the plurality of reactors 20d. The plasma supply line 42d may be connected to the reactor 20d disposed at the most upstream side among the plurality of reactors 20d.

A gas circulation line 41d may be connected to at least one of the plurality of reactors 20d. The gas circulation line 41d may be connected to the reactor 20d positioned at the most downstream side among the plurality of reactors 20d.

A manufacturing liquid supply line 43d may be connected to at least one of the plurality of reactors 20d. For example, the manufacturing liquid supply line 43d may be connected to the reactor 20d positioned at the most upstream side among the plurality of reactors 20d. In addition, the manufacturing liquid supply line 43d may be branched and connected to two or more reactors 20d. A nozzle 435d may be connected to the downstream side end of the manufacturing liquid supply line 43d in the same or similar manner as described above in FIG. 7.

In addition, the manufacturing liquid supply line 43d may be connected to at least one liquid circulation line 46d in the same or similar manner as described above in FIG. 13. For example, the manufacturing liquid supply line 43d may be connected to the liquid circulation line 46d connected to the reactor 20d positioned at the most upstream side among the plurality of liquid circulation lines 46d. In addition, the manufacturing liquid supply line 43d may be branched and connected to two or more liquid circulation lines 46d.

In addition, the liquid circulation lines 46d line may be connected to the storage tank 30d in the same or similar manner as described above in FIG. 14.

FIG. 15 exemplarily illustrates a case in which the manufacturing liquid supply line 43d is connected to the reactor 20d positioned at the most upstream side among the plurality of reactors 20d.

A gas supply line 45d may be connected to the gas circulation line 41d in the same or similar manner as described above in FIG. 2. In addition, the gas supply line 45d may be connected to at least one of the plurality of reactors 20d in the same or similar manner as described above in FIG. 12. For example, the supply line 45d may connected to the reactor 20d disposed at the most downstream side among the plurality of reactors 20d. In addition, the gas supply line 45d may be connected to two or more reactors 20d. FIG. 15 exemplarily illustrates a case in which the gas supply line 45d is connected to the gas circulation line 41d.

A liquid discharge line 44d may be connected to a storage tank 30d. An activated water supply line 47d may be connected to the storage tank 30d.

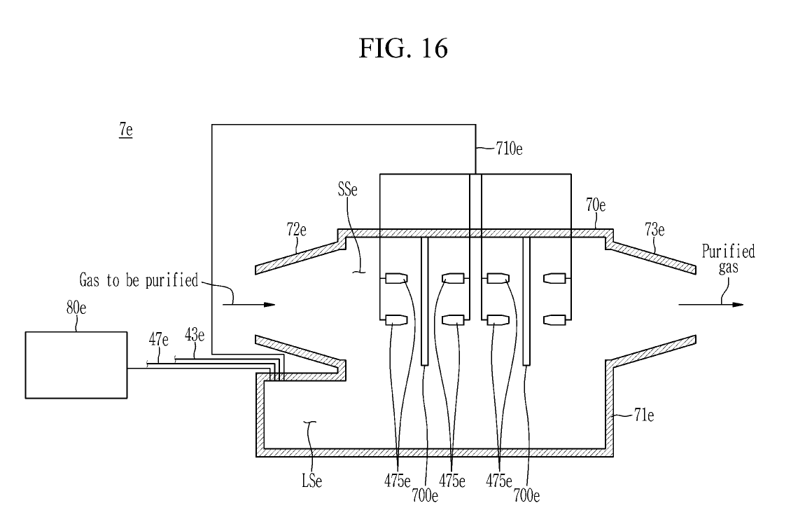

FIG. 16 shows a scrubber 7e according to another embodiment.

Referring to FIG. 16, the scrubber 7e may include a gas purification portion 70e and a liquid storage portion 71e.

Hereinafter, duplicate descriptions of a part that is identical or similar to that described above in FIG. 8 will be omitted and a difference will be described.

A gas purification space SSe may be disposed inside a gas purification portion 70e in which gas is purified by reacting with plasma-activated water. The gas purification portion 70e has a structure in which both ends in the length direction are open, and a gas inflow portion 72e may be disposed at one end in the length direction of the gas purification portion 70e, and a gas discharge portion 73e may be disposed at the other end in the length direction of the gas purification portion 70e.

At least one purification auxiliary member 700e may be disposed in the gas purification portion 70e.

The liquid storage portion 71e may be connected to one side of the gas purification portion 70e. A liquid storage space LSe for storing liquid may be disposed inside the liquid storage portion 71e.

A supply tank 80e may be connected to a scrubber 7e. An upstream side end of a manufacturing liquid supply line 43e may be connected to the scrubber 7e.

A downstream side end of an activated water supply line 47e is connected to a liquid storage portion 71e, and thus plasma-activated water may be supplied to the liquid storage space LSe.

The liquid storage portion 71e and the gas purification portion 70e may be connected through a liquid spray line 710e. The upstream side end of the liquid spray line 710e may be connected to the liquid storage portion 71e, and a downstream side end of the liquid spray line 710e may be connected to the gas purification portion 70e. Accordingly, the liquid stored in the liquid storage portion 71e may be supplied to the gas purification portion 70e and then sprayed into the gas purification space SSe. For example, a purification nozzle 475e may be disposed inside the gas purification portion 70e, and a downstream side end of the liquid spray line 710e may be connected to the purification nozzle 475e.

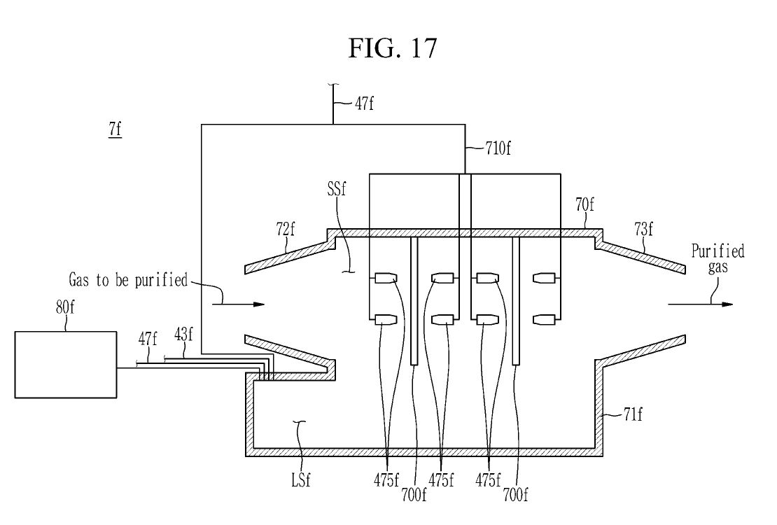

FIG. 17 shows a scrubber 7f according to another embodiment.

Referring to FIG. 17, a scrubber 7f may include a gas purification portion 70f and a liquid storage portion 71f.

Hereinafter, duplicate descriptions of a part that is identical or similar to that described above in FIG. 8 will be omitted and a difference will be described.

A gas purification space SSf may be disposed inside a gas purification portion 70f in which gas is purified by reacting with plasma-activated water. The gas purification portion 70f has a structure in which both ends in the length direction are open, and a gas inflow portion 72f may be disposed at one end in the length direction of the gas purification portion 70f, and a gas discharge portion 73f may be disposed at the other end in the length direction of the gas purification portion 70f.

At least one purification auxiliary member 700f may be disposed in the gas purification portion 70f.

The liquid storage portion 71f may be connected to one side of the gas purification portion 70f. A liquid storage space LSf for storing liquid may be disposed inside the liquid storage portion 71f.

The scrubber 7f may be provided with a supply tank 80f. An upstream side end of a manufacturing liquid supply line 43f may be connected to the scrubber 7f.

The liquid storage portion 71f and the gas purification portion 70f may be connected through a liquid spray line 710f. The upstream side end of the liquid spray line 710f may be connected to the liquid storage portion 71f, and a downstream side end of the liquid spray line 710f may be connected to the gas purification portion 70f. Accordingly, the liquid stored in the liquid storage portion 71f may be supplied to the gas purification portion 70f and then sprayed into the gas purification space SSf. For example, a purification nozzle 475f may be disposed inside the gas purification portion 70f, and a downstream side end of the liquid spray line 710f may be connected to the purification nozzle 475f.

A downstream side end of the activated water supply line 47f is branched and may be connected to the liquid storage portion 71f and the liquid spray line 710f, respectively. That is, the downstream side end of the activated water supply line 47f is connected to the liquid storage portion 71f, and thus plasma-activated water may be supplied to the liquid storage space LSf. In addition, the downstream side end of the activated water supply line 47f is connected to the liquid spray line 710f, and thus the plasma-activated water supplied through the activated water supply line 47f may be sprayed through the purification nozzle 475f.

A method for treating an exhaust gas from a semiconductor production facility according to an aspect of the disclosure includes (i) providing the exhaust gas to a gas treatment apparatus including: a scrubber; and a plasma-activated water producing module that is connected to the scrubber and supplies plasma-activated water, wherein the plasma-activated water producing module includes: a plasma reactor that excites a plasma generating gas into a plasma state; at least one reactor where plasma supplied from the plasma reactor and an activated water producing liquid are mixed and plasma-activated water is produced; and a storage tank that is connected to the at least one reactor and stores the plasma-activated water produced in the at least one reactor; and (b) contacting the exhaust gas with the plasma-activated water in the scrubber to remove material contained in the exhaust gas. In another aspect of the disclosure, the material being removed from the exhaust gas includes ammonia. In still another aspect of the disclosure, the material being removed from the exhaust gas includes total hydrocarbon. In yet another aspect of the disclosure, the material being removed from the exhaust gas includes ammonia and total hydrocarbon.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A gas treatment apparatus comprising:
a scrubber; and
a plasma-activated water producing module that is connected to the scrubber and that is configured to supply plasma-activated water,
wherein the plasma-activated water producing module comprises:
a plasma reactor that is configured to excite a plasma generating gas into a plasma state;
at least one reactor configured to mix plasma supplied from the plasma reactor and an activated water producing liquid and configured to produce the plasma-activated water; and
a storage tank that is connected to the at least one reactor and that is configured to store the plasma-activated water produced in the at least one reactor.

2. The gas treatment apparatus of claim 1, wherein the plasma-activated water producing module further comprises:
a gas circulation line that is connected to the at least one reactor and the plasma reactor and that is configured to supply a gas inside the at least one reactor to the plasma reactor; and
a gas supply line of which a downstream side end is connected to the gas circulation line and that is configured to supply the plasma generating gas.

3. The gas treatment apparatus of claim 2, wherein the plasma generating gas comprises oxygen gas and nitrogen gas.

4. The gas treatment apparatus of claim 2, wherein an upstream side end of the gas supply line is configured to be exposed to atmospheric air.

5. The gas treatment apparatus of claim 1, wherein the plasma-activated water producing module further comprises a gas supply line of which a downstream side end is connected to the at least one reactor and that is configured to supply the plasma generating gas.

6. The gas treatment apparatus of claim 1, further comprising a manufacturing liquid supply line that connects the scrubber and the at least one reactor and that is configured to supply the activated water producing liquid from the scrubber to the at least one reactor.

7. The gas treatment apparatus of claim 1, wherein the plasma-activated water producing module further comprises a liquid circulation line that connects the storage tank and the at least one reactor.

8. The gas treatment apparatus of claim 7, further comprising a manufacturing liquid supply line that connects the scrubber and the liquid circulation line and that is configured to supply the activated water producing liquid from the scrubber to the liquid circulation line.

9. The gas treatment apparatus of claim 1, further comprising a manufacturing liquid supply line that connects the scrubber and the storage tank and that is configured to supply the activated water producing liquid from the scrubber to the storage tank.

10. The gas treatment apparatus of claim 1, wherein the at least one reactor is a plurality of reactors.

11. The gas treatment apparatus of claim 10, wherein the plurality of reactors are connected in series through a reactor connection line.

12. The gas treatment apparatus of claim 11, wherein the plasma reactor is connected to a reactor at a most upstream side among the plurality of reactors through a plasma supply line.

13. The gas treatment apparatus of claim 11, wherein the plasma reactor is connected to a reactor at a most downstream side among the plurality of reactors through a gas circulation line.

14. A gas treatment apparatus comprising:
a scrubber; and
a plasma-activated water producing module that is connected to the scrubber and that is configured to supply plasma-activated water to the scrubber,
wherein the plasma-activated water producing module comprises:
a plasma reactor comprising at least one reactor module that is configured to excite a plasma generating gas into a plasma state;
at least one reactor that is configured to mix plasma and activated water producing liquid and that is configured to produce the plasma-activated water;
a plasma supply line that connects the plasma reactor and the at least one reactor and that is configured to supply plasma to the at least one reactor;
a gas circulation line that connects the at least one reactor and the plasma reactor and that is configured to supply gas discharged from the at least one reactor to the plasma reactor; and
a storage tank that is connected to the bottom of the at least one reactor and that is configured to store the plasma-activated water produced in the at least one reactor.

15. The gas treatment apparatus of claim 14, wherein the at least one reactor module is a plurality of reactor modules, and the plurality of reactor modules are arranged in parallel.

16. The gas treatment apparatus of claim 14, further comprising:
an activated-water supply line that connects the storage tank and the scrubber and that is configured to supply the plasma-activated water to the scrubber; and
a manufacturing liquid supply line that connects the scrubber and the at least one reactor and that is configured to supply the activated water producing liquid to the at least one reactor.

17. The gas treatment apparatus of claim 14, further comprising:
an activated water supply line that connects the storage tank and the scrubber and that is configured to supply the plasma-activated water to the scrubber;
a gas supply line of which a downstream side end is connected to the gas circulation line and that is configured to supply the plasma generating gas; and
a manufacturing liquid supply line that connects the scrubber and the at least one reactor and that is configured to supply the activated water producing liquid to the at least one reactor.

18. The gas treatment apparatus of claim 14, wherein:
the plasma-activated water producing module further comprises a liquid circulation line that connects the storage tank and the at least one reactor, and
the gas treatment apparatus further comprises:
an activated water supply line that connects the storage tank and the scrubber and that is configured to supply the plasma-activated water to the scrubber; and
a manufacturing liquid supply line that connects the scrubber and the liquid circulation line and that is configured to supply the activated water producing liquid to the liquid circulation line.

19. The gas treatment apparatus of claim 14, further comprising:
an activated water supply line that connects the storage tank and the scrubber and that is configured to supply the plasma-activated water to the scrubber; and
a manufacturing liquid supply line that connects the scrubber and the storage tank and that is configured to supply the activated water producing liquid to the storage tank.

20. A gas treatment apparatus comprising:
a scrubber;
a plasma-activated water producing module that is configured to produce plasma-activated water by dissolving plasma into an activated water producing liquid;
an activated water supply line that connects the plasma-activated water producing module and the scrubber and that is configured to supply the plasma-activated water to the scrubber; and
a manufacturing liquid supply line that connects the scrubber and the plasma-activated water producing module and that is configured to supply the activated-water producing liquid to the plasma-activated water producing module,
wherein the plasma-activated water producing module comprises:
a plasma reactor comprising at least one reactor module that is configured to excite a plasma generating gas into a plasma state;
at least one reactor that is configured to mix plasma and the activated water producing liquid and that is configured to produce the plasma-activated water;
a plasma supply line that connects the plasma reactor and the at least one reactor and that is configured to supply plasma to the at least one reactor;
a gas circulation line that connects the at least one reactor and the plasma reactor and that is configured to supply gas discharged from the at least one reactor to the plasma reactor; and
a storage tank that is connected to the at least one reactor and that is configured to store the plasma-activated water produced in the at least one reactor.
